(19) United States
(12) Patent Application Publication
(10) Pub. No.: US 2025/0101801 A1
(43) Pub. Date: Mar. 27, 2025

(54) BELLOW-SHAPED INSECT NETTING FOR A VENTILATION WINDOW OF A GREENHOUSE AND A GREENHOUSE

(71) Applicant: HOLLAND GAAS B.V., Maasdijk (NL)

(72) Inventors: Roland Haaring, ’s-Gravenzande (NL); Ronald Wilhelmus Van Markwijk, Poeldijk (NL); Willem Seger Gerard Van Geest, Naaldwijk (NL); Marcel Johannes Gerardus Schulte, Honselersdijk (NL)

(21) Appl. No.: 18/893,225

(22) Filed: Sep. 23, 2024

(30) Foreign Application Priority Data
Sep. 27, 2023 (EP) 23200105.7

(51) Int. Cl. E06B 9/52; A01G 9/24

(52) U.S. Cl. CPC E06B 9/52; A01G 9/241; E06B 2009/528

(57) ABSTRACT

An insect netting for a greenhouse has folded and unfolded conditions, the latter in which the netting forms first and second walls which meet each other at a corner portion. The netting comprises a plurality of bellow sections. Each bellow has a first bellow portion and a second bellow portion The first bellow portion comprises a first strip along the first wall and a second strip along the second wall which are fixed to each other through a first seam at mutual rims of the first and second strips of the first bellow portion which face each other at a corner portion. The second bellow portion is similarly constructed. The first seam and the second seam of the first and second bellow portions have different locations at the corner portion as seen in a direction perpendicular to a plane in which the bellow section lies in the folded condition.

### CROSS-REFERENCE TO RELATED APPLICATION

The present application is based on and claims the benefit of European patent application Serial No. 23200105.7, filed Sep. 27, 2023, the content of which is hereby incorporated by reference in its entirety.

### BACKGROUND

The discussion below is merely provided for general background information and is not intended to be used as an aid in determining the scope of the claimed subject matter.

Aspects of the present invention relates to a bellow-shaped insect netting for a ventilation window of a greenhouse, having a folded condition in which the insect netting is compacted and an unfolded condition in which the insect netting forms at least a first wall and a second wall which are angled with respect to each other and meet each other at a corner portion, thus forming an inner side and an outer side of the insect netting, wherein the insect netting comprises a plurality of bellow sections, wherein each bellow section has a first bellow section portion and a second bellow section portion, which are fixed to each other at one of the inner side and the outer side so as to form a plie and lie onto each other in the folded condition, wherein the first bellow section portion comprises a first strip along the first wall and a second strip along the second wall which are fixed to each other through a first seam at mutual rims of the first and second strips of the first bellow section portion which face each other at the corner portion, and the second bellow section portion comprises a first strip along the first wall and a second strip along the second wall which are fixed to each other through a second seam at mutual rims of the first and second strips of the second bellow section portion which face each other at the corner portion.

Such an insect netting is known from WO 2022/245215. In the unfolded condition the known insect netting comprises a front panel which merges into two side panels. The side panels have a shape of a circle section. The insect netting comprises a plurality of U-shaped bellow sections, wherein each of the bellow sections has two parallel side bellow portions at the respective side panels and a front bellow portion at the front panel. Each of the side bellow portions comprises a first side gauze web and a second side gauze web connected to each other at a longitudinal side thereof and each having a short side. The front bellow portion comprises a first front gauze web and a second front gauze web connected to each other at a longitudinal side thereof. The short sides of the first and second side gauze webs are connected to the longitudinal sides of the first and second front gauze webs, respectively.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the Background.

An insect netting herein disclosed comprises the first seam and the second seam having different locations at the corner portion as seen in a direction perpendicular to a plane in which the bellow section lies in the folded condition of the insect netting.

An advantage of the insect netting is that the thickness of the bellow section at the corner portion is minimized in the folded condition, since the first seam and the second seam are shifted with respect to each other. This causes a relatively flat package of the insect netting in its folded condition.

The fact that the first and second strips of the first bellow section portion are fixed to each other through the first seam at mutual rims of the first and second strips of the first bellow section portion which face each other at the corner portion, means that an overlap of the first and second strips of the first bellow section portion is minimized. Similarly, the fact that the first and second strips of the second bellow section portion are fixed to each other through the second seam at mutual rims of the first and second strips of the first bellow section portion which face each other at the corner portion, means that an overlap of the first and second strips of the second bellow section portion is minimized. The first seam may be a single seam between the first and second strips of the first bellow section portion and the second seam may be a single seam between the first and second strips of the second bellow section portion.

In an embodiment the first seam and the second seam are angled with respect to each other at the corner portion as seen in a direction perpendicular to the plane in which the bellow section lies in the folded condition of the insect netting.

The first wall and the second wall may be substantially perpendicular to each other. This means that the first and second strips of the first bellow section portion are substantially perpendicular to each other and the first and second strips of the second bellow section portion are substantially perpendicular to each other.

In an embodiment at the corner portion a transverse end of the first strip of the first bellow section portion is fixed to a longitudinal side of the second strip of the first bellow section portion, wherein at the corner portion a transverse end of the second strip of the second bellow section portion is fixed to a longitudinal side of the first strip of the second bellow section portion. The transverse end of the first strip of the first bellow section portion may be perpendicular to a longitudinal direction of the first strip of the first bellow section portion and parallel to the longitudinal side of the second strip of the first bellow section portion, whereas the transverse end of the second strip of the second bellow section portion may be perpendicular to a longitudinal direction of the second strip of the second bellow section portion and parallel to the longitudinal side of the first strip of the second bellow section portion. The first and second strips of the first and second bellow section portions may be rectangular. The first and second seam may be perpendicular to each other as seen in a direction perpendicular to the plane in which the bellow section lies in the folded condition of the insect netting.

In a particular embodiment the first bellow section portion is a lower bellow section portion and the second bellow section portion is an upper bellow section portion extending above the upper bellow section portion, wherein the first strip of the upper bellow section portion extends above the first strip of the lower bellow section portion and an end portion of the second strip of the lower bellow section portion, whereas the second strip of the lower bellow section portion extends below the second strip of the upper bellow section portion and an end portion of the first strip of the upper bellow section portion. In this embodiment the first and second bellow section portions lie above each other. The first and second panel may extend in upward direction.

The insect netting may be fused, stitched or adhered at the first and second seams.

The first bellow section portion and the second bellow section portion may be fused, stitched or adhered to each other at one of the inner side and the outer side.

The first and second strips of the first and second bellow section portions are elongated pieces, preferably made of a fine mesh gauze.

In a particular embodiment the bellow section has a U-shape such that the insect netting can be used at a tilt window. The U-shape may fit to three free edges of a rectangular tilt window.

An aspect of the invention is also related to a greenhouse, comprising an inclined roof including an opening and a ventilation window which is rotatable between a closed condition in which it covers the opening and an open condition in which the opening forms a ventilation passage, wherein the greenhouse further comprises an insect netting as described hereinbefore, which insect netting is mounted to the ventilation window and surrounding edges around the opening.

### BRIEF DESCRIPTION OF THE DRAWINGS

Aspects of the invention will hereafter be elucidated with reference to very schematic drawings showing embodiments of the invention by way of example.

FIG. 1 is a perspective view of a part of an embodiment of a greenhouse including an insect netting.

FIG. 2 is a pan view of a part of a lower bellow section portion of the insect netting of FIG. 1.

FIG. 3 is a similar view as FIG. 2, but showing a part of an upper bellow section portion of the insect netting of FIG. 1.

FIG. 4 is a perspective view of a part of the insect netting of FIG. 1, illustrating how the upper bellow section portions and the lower bellow section portions are fixed to each other.

FIG. 5 is a cross-sectional view along the line V-V in FIG. 4, when the lower and upper bellow section portions are fixed to each other and in the unfolded condition of the insect netting.

FIG. 6 is an enlarged perspective view of a part of FIG. 1, illustrating the insect netting in an unfolded condition.

FIGS. 7 and 8 are similar views as FIG. 4, showing alternative embodiments of the insect netting.

### DETAILED DESCRIPTION OF ILLUSTRATIVE EMBODIMENTS

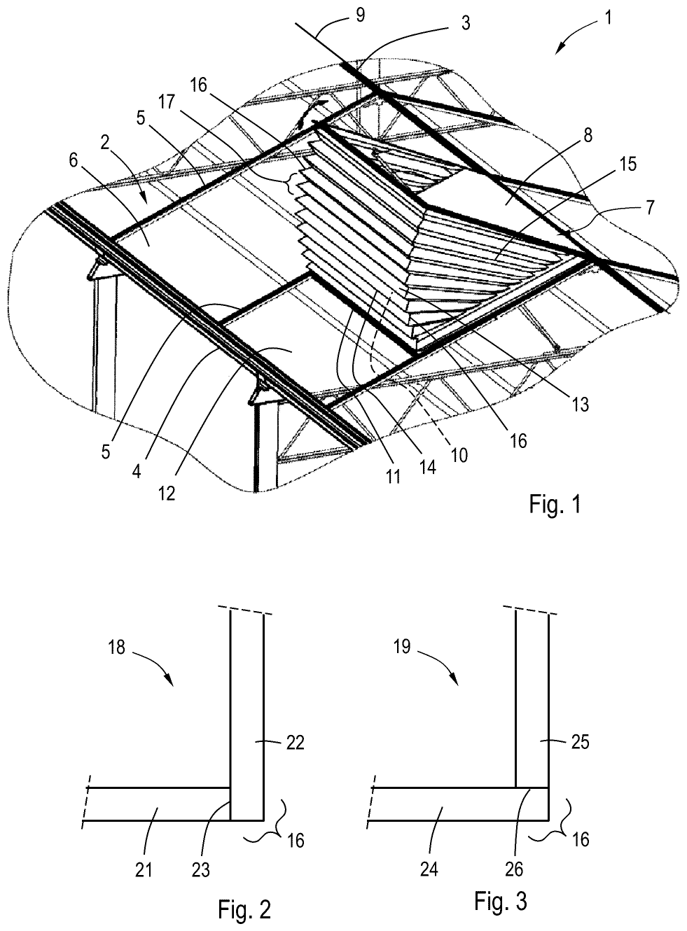

FIG. 1 shows a part of an embodiment of a greenhouse 1. The greenhouse 1 is of the Venlo type and has an inclined roof 2. The roof 2 has a ridge 3 and a gutter 4 which extend parallel to each other. Parallel window profiles 5 extend between the gutter 4 and the ridge 3 and are perpendicular with respect to the gutter 4 and the ridge 3. The ridge 3, the gutter 4 and the window profiles 5 form rectangular rabbets for glass panels 6.

The roof 2 is provided with a ventilation window 7 which comprises a glass panel 8, as well. An upper rim of the ventilation window 7 is pivotally mounted to the ridge 3 such that the ventilation window 7 is rotatable about a pivot axis 9 with respect to the ridge 3.

The ventilation window 7 is rotatable between a closed condition in which it covers a rectangular opening 10 in the roof 2 and an open condition in which the opening 10 forms a ventilation passage. FIG. 1 shows the ventilation window 7 in its open condition. The opening 10 is surrounded by two neighbouring window profiles 5, the ridge 3 and an intermediate rod 11 between the neighbouring window profiles 5. The gutter 4, the neighbouring window profiles 5 and the intermediate rod 11 form a rectangular rabbet for a glass panel 12.

The greenhouse 1 is provided with a bellow-shaped insect netting 13 to prevent insects from entering an inner side of the greenhouse 1 when the ventilation window 7 is in the open condition. The insect netting 13 comprises a fine mesh gauze. It is fixed along free edges of the ventilation window 7 and along cooperating edges around the opening 10. The cooperating edges around the opening 10 are formed by portions of the neighbouring window profiles 5 and the intermediate rod 11. The free edges of the ventilation window 7, i.e. the edges outside the upper rim that is pivotally mounted to the ridge 3, and the cooperating edges around the opening 10 have U shapes, respectively. The insect netting 13 may be fixed to the free edges of the ventilation window 7 and the cooperating edges around the opening 10 through flexible elements such as rubber (not shown).

When the ventilation window 7 is in the closed condition the insect netting 13 is in a folded condition and when the ventilation window 7 is in the open condition the insect netting 13 is in an unfolded condition. The latter condition is shown in FIG. 1. In the folded condition the insect netting 13 is collapsed or compacted and sandwiched between the free edges of the ventilation window 7 and the cooperating edges around the opening 10. In the unfolded condition the insect netting 13 forms a front wall 14 and two opposite side walls 15. Each of the side walls 15 is angled with respect to the front wall 14. In this case the front wall 14 is perpendicular to each of the side walls 15. In the embodiment as shown in FIG. 1 the front wall 14 is curved and the side walls 15 form respective circle sections, since the ventilation window 7 is a tilt window. This may be different in an alternative shape of the ventilation window 7. The front wall 14 meets the side walls 15 at respective corner portions 16. The front wall 14 and the side walls 15 have an inner side of the insect netting 13 which is exposed to an inner side of the greenhouse 1 and an outer side which is exposed to an outer side of the greenhouse 1.

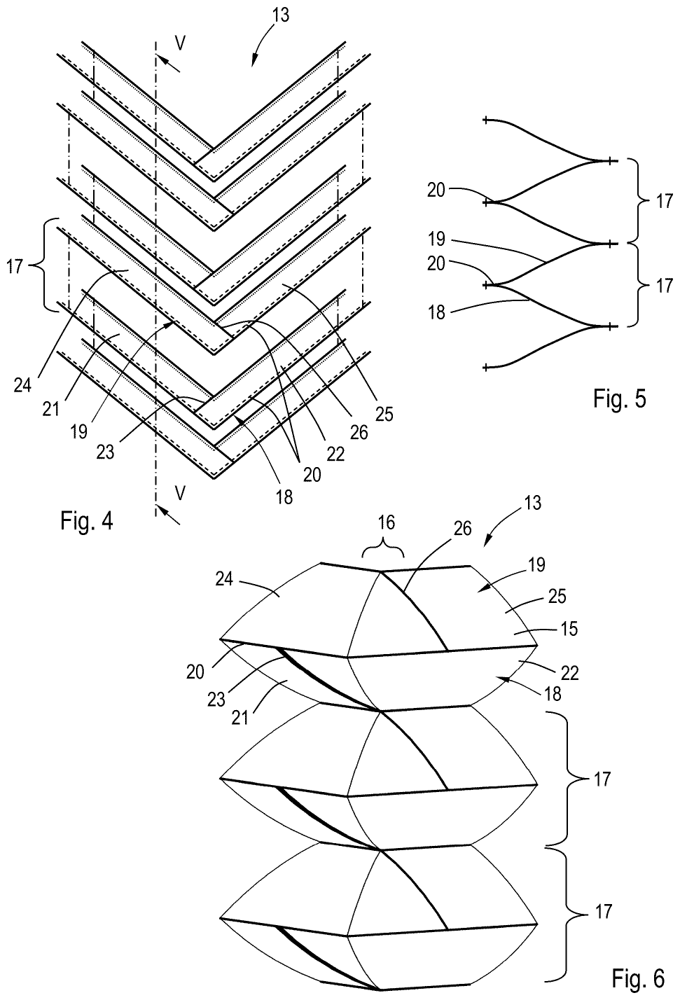

The insect netting 13 comprises a plurality of bellow sections 17 which are arranged above each other in order to form the bellow shape. Each bellow section 17 has a U-shape including a base and two legs, wherein the legs are part of the respective side panels 15 and the base is part of the front panel 14. FIGS. 2 and 3 show portions of one bellow section 17. FIGS. 4 and 5 show how the bellow sections 17 are fixed to each other. Each bellow section 17 has a lower bellow section portion 18 and an upper bellow section portion 19, which are fixed to each other at the outer side of the insect netting 13 so as to form a plie and lie onto each other in the folded condition. Adjacent bellow sections 17 are fixed to each other at the inner side of the insect netting 13. The fixations at the inner side and the outer side of the insect netting 13 are illustrated by vertical dash-dotted lines in FIG. 4.

FIG. 5 shows a cross-section of the bellow sections 17 at the front panel 14 in the unfolded condition, illustrating that each of the bellow sections 17 forms a plie. In this case the upper bellow section portion 19 and the lower bellow section portion 18 are fixed to each other by means of welding, therewith forming a welding area 20 which extends along the bellow section 17. Alternatively, the upper bellow section portion 19 and the lower bellow section portion 18 may be fixed to each other by means of adhesive, stitching, fusing or the like. The bellow sections 17 are fixed to each other at the inner side of the insect netting 13 in a similar way.

Referring to FIGS. 2 and 3, the lower bellow section portion 18 comprises a rectangular first strip 21 along the front wall 14 and two parallel rectangular second strips 22 along the respective side walls 15 which meet each other at the respective corner portions 16. The first strip 21 of the lower bellow section portion 18 is fixed to each of the second strips 22 of the lower bellow section portion through respective lower seams 23 at the respective corner portions 16. Similarly, the upper bellow section portion 19 comprises a rectangular first strip 24 along the front wall 14 and two parallel rectangular second strips 25 along the respective side walls 15. The first strip 24 of the upper bellow section portion 19 is fixed to each of the second strips 25 of the upper bellow section portion 19 through respective upper seams 26 at the respective corner portions 16.

At each of the corner portions 16 a transverse end of the first strip 21 of the lower bellow section portion 18 is fixed to a longitudinal side of the second strip 22 of the lower bellow section portion 18 which face each other, whereas a transverse end of the second strip 25 of the upper bellow section portion 19 is fixed to a longitudinal side of the first strip 24 of the upper bellow section portion 19 which face each other. The first strip 21 and the second strip 22 of the lower bellow section portion 18 may be fixed to each other at the lower seam 23 by means of stitching, welding, adhesive, fusing or the like. Similarly, the first strip 24 and the second strip 25 of the upper bellow section portion 19 may be fixed to each other at the upper seam 26 by means of stitching, welding, adhesive, fusing or the like.

Referring to FIG. 4, the first strip 24 of the upper bellow section portion 19 extends above the first strip 21 of the lower bellow section portion 18 and an end portion of the second strip 22 of the lower bellow section portion 18, whereas the second strip 22 of the lower bellow section portion 18 extends below the second strip 25 of the upper bellow section portion 19 and an end portion of the first strip 24 of the upper bellow section portion 19.

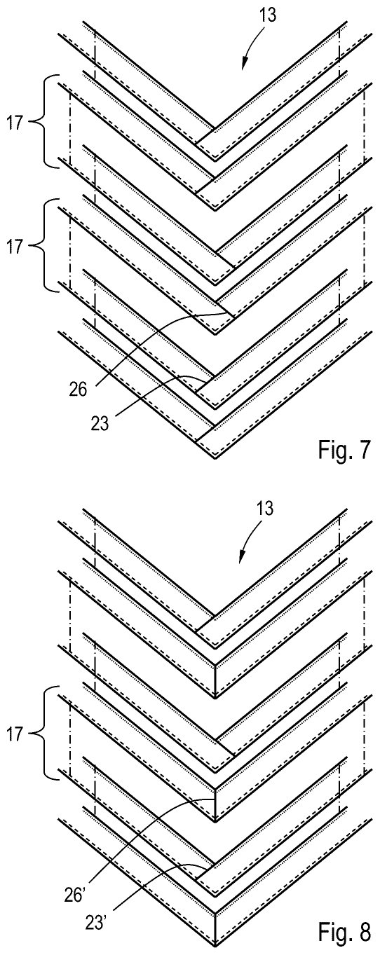

FIG. 6 shows a portion of the insect netting 13 at one of the corner portions 16 in its unfolded condition. Since the upper and lower seams 23, 26 of each of the successive bellow sections 17 are not placed onto each other in the folded condition the ventilation window 7 can close evenly on the edges around the opening 10 of the roof 2. It is noted that in FIG. 6 neighbouring bellow sections 17 are the same at the corner portion 16, i.e. the lower seam 23 at the lower bellow section portions 18 lie at the same location of each of the bellow sections 17 at the corner portion 16 and the upper seam 26 at the upper bellow section portion 19 lie at the same location of each of the bellow sections 17 at the corner portion 16. This may be different in an alternative embodiment. This is illustrated in the embodiment as shown in FIG. 7, which still has a bellow section 17 in which the lower seam 23 and the upper seam 26 have different locations at the corner portion 16 as seen in a direction perpendicular to a plane in which the bellow section 17 lies in the folded condition of the insect netting 13.

FIG. 8 shows another alternative embodiment, which has a bellow section 17 in which the lower seam 23′ and the upper seam 26′ are not perpendicular to each other, but which still have different locations and orientations at the corner portion 16 as seen in a direction perpendicular to a plane in which the bellow section 17 lies in the folded condition of the insect netting 13.

The invention is not limited to the embodiments shown in the drawings and described hereinbefore, which may be varied in different manners within the scope of the claims and their technical equivalents.

What is claimed is:

1. A bellow-shaped insect netting for a ventilation window of a greenhouse, having a folded condition in which the insect netting is compacted and an unfolded condition in which the insect netting forms at least a first wall and a second wall which are angled with respect to each other and meet each other at a corner portion, thus forming an inner side and an outer side of the insect netting, wherein the insect netting comprises a plurality of bellow sections, wherein each bellow section has a first bellow section portion and a second bellow section portion, which are fixed to each other at one of the inner side and the outer side so as to form a plie and lie onto each other in the folded condition, wherein the first bellow section portion comprises a first strip along the first wall and a second strip along the second wall which are fixed to each other through a first seam at mutual rims of the first and second strips of the first bellow section portion which face each other at the corner portion, and the second bellow section portion comprises a first strip along the first wall and a second strip along the second wall which are fixed to each other through a second seam at mutual rims of the first and second strips of the second bellow section portion which face each other at the corner portion, wherein the first seam and the second seam have different locations at the corner portion as seen in a direction perpendicular to a plane in which the bellow section lies in the folded condition of the insect netting.

2. The bellow-shaped insect netting according to claim 1, wherein the first seam and the second seam are angled with respect to each other at the corner portion as seen in a direction perpendicular to the plane in which the bellow section lies in the folded condition of the insect netting.

3. The bellow-shaped insect netting according to claim 1, wherein the first wall and the second wall are substantially perpendicular to each other.

4. The bellow-shaped insect netting according to claim 3, wherein at the corner portion a transverse end of the first strip of the first bellow section portion is fixed to a longitudinal side of the second strip of the first bellow section portion, wherein at the corner portion a transverse end of the second strip of the second bellow section portion is fixed to a longitudinal side of the first strip of the second bellow section portion.

5. The bellow-shaped insect netting according to claim 4, wherein the first bellow section portion is a lower bellow section portion and the second bellow section portion is an upper bellow section portion extending above the lower bellow section portion, wherein the first strip of the upper bellow section portion extends above the first strip of the lower bellow section portion and an end portion of the second strip of the lower bellow section portion, whereas the second strip of the lower bellow section portion extends below the second strip of the upper bellow section portion and an end portion of the first strip of the upper bellow section portion.

6. The bellow-shaped insect netting according to claim 1, wherein the insect netting is fused, stitched or adhered at the first and second seams.

7. The bellow-shaped insect netting according to claim 1, wherein the first bellow section portion and the second bellow section portion are fused, stitched or adhered to each other at one of the inner side and the outer side.

8. The bellow-shaped insect netting according to claim 1, wherein the first and second strips of the first and second bellow section portions are elongated pieces.

9. The bellow-shaped insect netting according to claim 1, wherein the bellow section has a U-shape.

10. A greenhouse comprising:
an inclined roof including an opening and a ventilation window which is rotatable between a closed condition in which it covers the opening and an open condition in which the opening forms a ventilation passage; and
an insect netting, which is mounted to the ventilation window and surrounding edges around the opening, the insect netting comprising: a bellow-shaped insect netting for a ventilation window of a greenhouse, having a folded condition in which the insect netting is compacted and an unfolded condition in which the insect netting forms at least a first wall and a second wall which are angled with respect to each other and meet each other at a corner portion, thus forming an inner side and an outer side of the insect netting, wherein the insect netting comprises a plurality of bellow sections, wherein each bellow section has a first bellow section portion and a second bellow section portion, which are fixed to each other at one of the inner side and the outer side so as to form a plie and lie onto each other in the folded condition, wherein the first bellow section portion comprises a first strip along the first wall and a second strip along the second wall which are fixed to each other through a first seam at mutual rims of the first and second strips of the first bellow section portion which face each other at the corner portion, and the second bellow section portion comprises a first strip along the first wall and a second strip along the second wall which are fixed to each other through a second seam at mutual rims of the first and second strips of the second bellow section portion which face each other at the corner portion, wherein the first seam and the second seam have different locations at the corner portion as seen in a direction perpendicular to a plane in which the bellow section lies in the folded condition of the insect netting.

11. The greenhouse according to claim 10, wherein the first seam and the second seam are angled with respect to each other at the corner portion as seen in a direction perpendicular to the plane in which the bellow section lies in the folded condition of the insect netting.

12. The greenhouse according to claim 11, wherein the first wall and the second wall are substantially perpendicular to each other.

13. The greenhouse according to claim 12, wherein at the corner portion a transverse end of the first strip of the first bellow section portion is fixed to a longitudinal side of the second strip of the first bellow section portion, wherein at the corner portion a transverse end of the second strip of the second bellow section portion is fixed to a longitudinal side of the first strip of the second bellow section portion.

14. The greenhouse according to claim 13, wherein the first bellow section portion is a lower bellow section portion and the second bellow section portion is an upper bellow section portion extending above the lower bellow section portion, wherein the first strip of the upper bellow section portion extends above the first strip of the lower bellow section portion and an end portion of the second strip of the lower bellow section portion, whereas the second strip of the lower bellow section portion extends below the second strip of the upper bellow section portion and an end portion of the first strip of the upper bellow section portion.

15. The greenhouse according to claim 10, wherein the insect netting is fused, stitched or adhered at the first and second seams.

16. The greenhouse according to claim 10, wherein the first bellow section portion and the second bellow section portion are fused, stitched or adhered to each other at one of the inner side and the outer side.

17. The greenhouse according to claim 10, wherein the first and second strips of the first and second bellow section portions are elongated pieces.

18. The greenhouse according to claim 10, wherein the bellow section has a U-shape.
